(19) United States
(12) Patent Application Publication
(10) Pub. No.: US 2009/0261162 A1
(43) Pub. Date: Oct. 22, 2009

(54) SECURE SYSTEM AND METHOD FOR PAYMENT CARD AND DATA STORAGE AND PROCESSING VIA INFORMATION SPLITTING

(76) Inventors: James B. Kargman, Chicago, IL (US); Marc Asher, Highland Park, IL (US)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/496,251

(22) Filed: Jul. 1, 2009

Related U.S. Application Data
(63) Continuation of application No. 11/869,641, filed on Oct. 9, 2007.
(60) Provisional application No. 60/891,315, filed on Feb. 23, 2007.
(60) Provisional application No. 60/953,943, filed on Aug. 3, 2007.

(51) Int. Cl. G06K 5/00

(52) U.S. Cl. 235/380

(57) ABSTRACT

A method is provided for securely storing and retrieving data. A data unit is split by an entity, into a first component and at least a further second component such that the data unit cannot be reconstructed without having the first and second component. The second component is stored on a secure server in a non-volatile memory, the secure server being separate from any entity that may store the first component. The first and second component of the data unit are then subsequently accessed by a secure data retriever who is not an originator of the data, where the second component is accessed from the secure server. The secure data retriever combines these components into the original data unit. The method is particularly applied in commerce for credit card information in which significant restrictions are placed on the permanent storage of such data.

### CROSS REFERENCE TO RELATED APPLICATIONS

This application is a continuation of Ser. No. 11/869,641 filed Oct. 9, 2007. The present application claims the benefit of U.S. Provisional Application No. 60/891,315, filed Feb. 23, 2007, and U.S. Provisional Application No. 60/953,943, filed Aug. 3, 2007, both herein incorporated by reference.

### BACKGROUND

The present invention is directed to providing a secure mechanism for storing and retrieving any data for which security is desired. This could include, but is not limited to, PINs (Personal Identification Numbers), codes, combinations, account numbers, passwords, customer data, medical data, proprietary, and other information.

The following discusses a preferred embodiment in which an exemplary use of credit card information is provided, but it should be understood that the invention can be applied to any data for which security or confidentiality is desired.

Credit cards have become an integral part of modern commerce. However, as their use has grown, their value to criminals has also grown. The disclosure of credit card information over the telephone, or on a website, carries with it a certain element of risk. For merchants, consumer activism has increased the cost and potential risk of mishandling consumer information.

The typical credit card is a plastic card with raised numbers and letters on the front and a magnetic stripe on the back. On the front of the card is the 16 digit customer account number, customer name, and expiration date in raised letters, suitable for embossing on a sales receipt. The magnetic stripe on the rear of the card contains the same information plus additional information such as the “Card Security Validation” number, which is also printed on the card but not in a raised letter format. These codes are used as additional security checks to assure that a card being used is not just a copy of a sales receipt with the embossed letters visible.

Physical possession of a credit card is sufficient to initiate and complete a payment transaction, since the magnetic stripe contains all of the necessary account and verification information required. The card number plus the expiration date are in raised print on the front of the card, and these two elements are sufficient to process a telephone sales transaction. The CCV or “Credit Card Verification” number is a printed number on the front or back of the card, is not raised, and therefore does not emboss on a sales receipt. This additional security code can serve to prove that the person initiating the transaction has now—or had—full access to the credit card.

Card information is vulnerable at any time it is communicated in any form to a 3^{rd} party and/or exists in plain text. In telephone sales transactions the card information is often transcribed either onto paper, or into a system. In online commerce applications card information is vulnerable when customers enter their card information, in transport to the destination system, and on the destination system in transit to the card processing company.

Some of the schemes used to capture and misuse credit card credentials have been: a) copying card data at the point of sale, either manually or on a magnetic card reader; b) altering the magnetic stripe to be different from the printed card information; c) replacing the card reader machine at a point of sale with a recording reader that captures card information; d) infiltrating the data processing staff of a large processor to gain access to millions of payment card records; e) intercepting or modifying web traffic when consumers enter their credit card numbers; f) creating web sites or links that impersonate or appear to be from legitimate companies or sources to deceive consumers into entering their card and other personal information to the thief directly; and g) gaining access to company networks and monitoring network traffic to extract credit card information.

In a typical transaction, a merchant receives an order from a customer who chooses to pay by credit card, and the merchant captures the card number and sends this data to a the card processor. For future purchases both the customer and the merchant want to have the card information stored, so that the customer does not have to retrieve and communicate the card number again. Each time the card information is communicated is another opportunity for compromise. However, for the reasons noted above, this creates a risk with regard to the secure storage of the user's data.

Once card information has been received by a merchant, it is susceptible to compromise unless it is handled in secure manner. For this reason the payment card industry discourages the storage of credit card information except where extensive and comprehensive security mechanisms are in place. The paradox on this case is that if the credit card information is not stored at the merchant for use in subsequent transactions, the card information must be communicated again in plain text each time a credit card purchase is made, exposing the card information to compromise each and every time it is used. At the same time, the storage of the information presents a target for hackers, thieves, social engineering, and other assaults.

This second level of exposure is created by the long term storage of card information on a server for the convenience of a returning customer making a repeat purchase. This increases the risk related to handling card information. While encryption can provide a certain level of security, it is only as good as the key management, and security mechanisms used to protect the encryption algorithm. An increasing number of governmental regulations, moreover, carry penalties and other requirements for businesses in the event of a compromise of consumer credit information, and it can be assumed that over time these regulations will continue to become more and more costly to comply with.

As part of their response to these challenges, the payment card industry has set forth a set of guidelines and procedures designed to make it very difficult to gain access to card information. These methods include written security procedure manuals and methods that must be adhered to, daily scanning for vulnerabilities in computer networks, standards for secure networks, firewall, intrusion detection, and network architecture, as well as security practice standards, such as changing passwords on a regular basis and methods to assure that code properly documented, tested, and is not tampered with.

One of the goals of various security methods is to reduce the “attack surface” as well as the auditability of a system, so that a very high degree of authorization is required to gain access to credit card information, that all access to credit card information is logged and trackable to each individual who may have access.

One of the PCI guidelines is that once a credit card is entered into a system, the card data is never presented in clear text again, except possibly for the last 4 or 5 digits to identify the card. However, if the card number is being stored for re-use, even if it is encrypted, it is potentially vulnerable, if only because of where it is stored. If a competent, knowledgeable thief can gain access to a system where all of the card data is stored, the data is vulnerable. For this reason, the last line of defense is encryption of the card information.

The methods of encryption today involve the use of either “one time pads” or a random list of values which are created and used only one time to both encode and decode the data, or the use of mathematical algorithms that manipulate the data in a way that would require hundreds or thousands of years of computer time to brute force decrypt. The problem with these methods is that one time pads can only be used once, and must exist at both the encryption location as well as the decryption location, doubling the vulnerability. Moreover, the planned development of multiple core cpu architectures, with over 100 processors per chip, or the development work on so called “quantum computers” has the potential to make today's encryption algorithms easier to brute force attack as the technology advances.

The large monetary value of stolen credit cards, and the growing threat of high tech attacks on their integrity, combined with the great cost and difficulty involved in protecting systems from intrusion from these ever increasing threats, requires a new approach to credit card security that provides consumers the maximum possible in convenience and ease of use, while eliminating the possibility of fraudulent use of the card outside of the authorized relationship established by a consumer with a merchant.

### SUMMARY

The invention provides a high security mechanism for stored sensitive information that cannot be compromised by a successful security breach at one location. In broad terms, a system and method is provided to reduce the exposure and risk of storing sensitive information by eliminating the storage of the complete information on a single computer system, while preserving the convenience aspect for a user of being able to re-use their sensitive information without having to enter it every time they use it.

The invention very importantly provides an inherently greater assurance to the consumer that their information is safer than that provided by mere encryption methods that could be broken in the near future. This assurance is greater because the customer's information does not exist in just one place and, if segregated properly, is not vulnerable to the types of mathematical algorithms and computational power that could possibly compromise modern day encryption methods.

Accordingly, a method is provided for securely storing and retrieving data, comprising: in a first splitting stage: splitting, by a splitting entity, a data unit of a data originator into a first component and at least a further second component such that the data unit cannot be reconstructed without having the first and second component; and storing the second component on a secure server in a non-volatile memory, the secure server being separate from any entity that may store the first component; and in a second accessing stage: accessing, by a secure data retriever who is not the data originator, the first component provided directly or indirectly by the data originator; accessing, by the data retriever, the second component from the secure server; combining the first component, the second component, and any further necessary components that make up the data unit by the data retriever into a retrieved data unit that is identical to the data unit that was split; and outputting the retrieved data unit to a user readable device or a system memory.

In various embodiments, the sensitive information is credit card information used in the context of a purchase by a customer from a merchant. In such embodiments, credit card information is captured from the consumer by card swipe, in person, over a telephone, or via a website. This data is encrypted and forwarded to a card processor. The card processor may transform and encrypt this data. The encryption may be implemented using an encoded merchant public-private key so that card information transmitted from a merchant can only be used by or for the benefit of that merchant. In an embodiment, the processor then creates a pointer value that includes the merchant identification, an encrypted value, plus the last four or five digits of the user's credit card. Any desired secure encryption mechanism can be used such as DES, triple DES, AES256, but note that with the invention, the encryption is not the last line of defense, but just another component of defense in depth.

A number of mechanisms may be provided to allow merchants to store a component of a secure vector (data containing or related to information about a secure data entity) on a remote Secure Vector Storage system. The secure store system may be a standalone system, or it may co-reside at a processor. The key values to identify and retrieve the secure vector may be provided by the merchant, or it may be an encrypted response returned by the Secure Vector Storage system when data is stored.

### DESCRIPTION OF THE DRAWINGS

The present invention is explained by way of example in various preferred embodiments illustrated in the drawings and appertaining descriptive portion below.

FIG. 1A is a high-level block diagram illustrating the components in a preferred embodiment of the invention;

FIG. 1B is a block diagram illustrating a splitter and combiner used in embodiments of the invention;

FIG. 2A is a block flow diagram illustrating a merchant split of the credit information;

FIG. 2B is a block flow diagram illustrating a secure store split of the credit information;

FIGS. 3A, B are parts of a flowchart illustrating an embodiment of the new customer processing flow;

FIGS. 4A, B are parts of a flowchart illustrating an embodiment of the repeat customer processing flow;

FIG. 5 is a screen view of an entry box for entering the split portions of the credit card information;

FIG. 6 is an overall flowchart illustrating the secure transaction process;

FIG. 7 is a flowchart illustrating the use of a voice response unit in the customer purchase process to split the credit card information;

FIG. 8 is a combination process and data flowchart according to an embodiment of the invention;

FIG. 9 is an exemplary process flow; and

FIG. 10 is a flowchart illustrating the encoding, according to an embodiment;

### DETAILED DESCRIPTION OF THE PREFERRED EMBODIMENTS

### System Overview

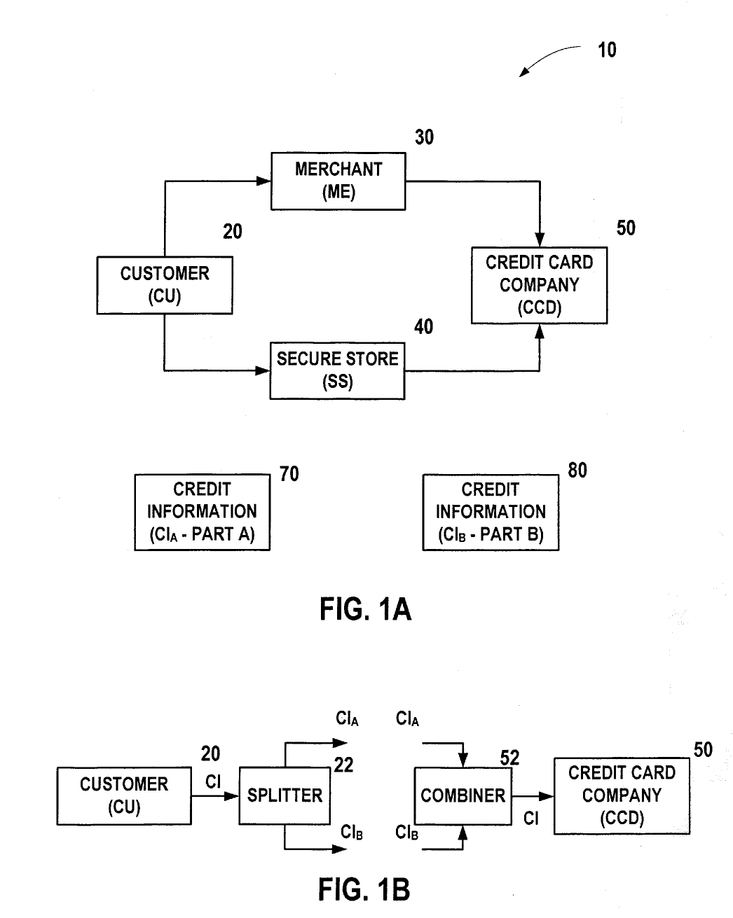

FIG. 1A illustrates the primary components of a preferred embodiment of a secure system 10. The primary components are the customer CU 20 who wishes to purchase goods and/or services from a merchant ME 30, using a credit card issued by a credit card company CCD 50. The secure store SS 40 is provided as a place in which information can be securely stored on a relatively permanent media. Credit card companies require that merchants adhere to a fairly stringent set of protocols defined, e.g., by the Payment Card Industry (PCI) Data Security Standard ver. 1.1 (September 2006) (“the PCI Standard”), herein incorporated by reference.

The credit information 70, 80 of a customer 20 in customary merchant 30 transactions is “in flight”, meaning that this information is not actually stored in any permanent or semi-permanent manner on the systems that are involved in a particular transaction, but rather exists only temporarily in memory or in secure communication links.

In some instances, it is desirable for this credit information to be “at rest”, i.e., stored on a permanent or semi-permanent media. However, such “at rest” or stored data is subject to much stricter system and security requirements by the PCI Standard, since in theory such information can be taken and compromised for the duration of its life (which can be a long time, given system backups and the like). What is important is to minimize the attack surface (i.e., the degree of exposure of sensitive credit card information to criminals) and thereby reduce the risk of loss.

In order to avoid the onerous requirements of the PCI Standard, while at the same time providing customers and vendors with some mechanism for storing credit card information, various embodiments of the invention propose to separate the credit card information into two or more pieces (Part A 70 and Part B 80) and store these pieces separately. The system 10 then ensures that the only entity that can put the two pieces together and thereby have all necessary information is the credit card company 50. Thus, no single entity has access to all of the customer's 20 credit card information except the customer 20 and the credit card company 50.

### Credit Card Information Splitting and the Initial Secure Store Purchase

Splitter/Combiner in General

FIG. 1B illustrates a splitter 22 that can be provided to facilitate the splitting of the credit information CI into its respective components CI_{A} and CI_{B}. The second component CI_{B} is stored in a permanent storage 42 of the secure store 40 or other secure storage site (possibly within the credit card company 50), upon a first transaction involving the secure store technology. Once this information CI_{B} is stored, the processes for storing this information do not have to be stored a second time.

It is also possible to store the first component CI_{A} on another permanent store, such as the permanent storage 32 of the merchant 30 without running afoul of the requirements in the PCI Standard, since the information necessary to compromise the credit card information is never stored in one place.

The splitting of the information could be implemented by any form of software, including web-based or OS-based modules, and could be self-contained or client-server based. Although FIG. 1B illustrates the splitter 22 being directly accessed by the customer, it could be located at any location, and not just at the customer's 20 site, although at the customer's site, and behind a firewall, is one of the preferred secure arrangements as the whole CI is inaccessible to those outside of the firewall.

It should be noted that the split in the credit card information used by the splitter 22 can be accomplished by a very basic separation, e.g., in the credit card number, where, for example, the first six and last four digits of a typical 16-digit credit card number are stored in a first location, and the middle six digits are stored in a second location. The split can also incorporate other relevant information for the credit card, such as the security code or the expiration date.

The split, however, can involve more sophisticated techniques including encryption and utilized various keys, such as with the well-known public and private key algorithms. Given this split, the customer credit card information can be stored permanently or semi-permanently while at the same time reducing risk, as well as the cost and complexity of complying with the PCI Standard.

A system defined by Cleversafe is able to save information on multiple remote systems and utilizes a storage technique that could be utilized in this instance. It stores data along with a data parity bit or bits such that access to only some of the remote locations permits reconstruction of the information. However, one should avoid implementing a system in which a reconstruction of one part of the customer's credit information 80 is sufficient to restore it all. Such a scheme, however, could be designed arbitrarily robust.

A corresponding combiner 52 can be provided that facilitates the merging of the split credit card components CI_{A} and CI_{B} into the original credit card information CI. In a preferred embodiment, the combiner is located on-site at the credit card company, behind a firewall to prevent access by outsiders to the combined CI.

Merchant as Splitter

According to one preferred embodiment, the merchant 30 is the entity that splits the credit card information upon a first use of the secure system 10 with the credit card. In this embodiment, the customer 20 makes an initial purchase with a merchant 30 by providing the merchant with the full credit card information. This scenario is somewhat disadvantageous because for this first transaction, the merchant 30 has all necessary credit card information. Therefore, if a dishonest employee of the merchant 30 copies the customer credit card information, he can impersonate the customer 20 and make illicit purchases. In this scenario, however, it is only the first transaction that is subject to this exposure.

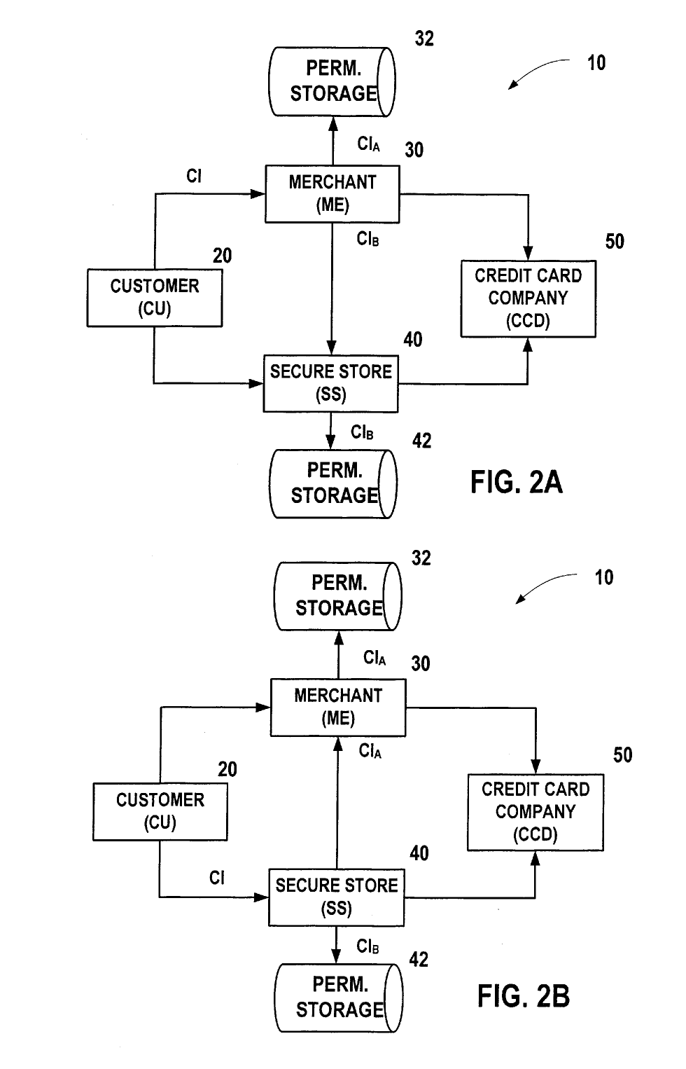

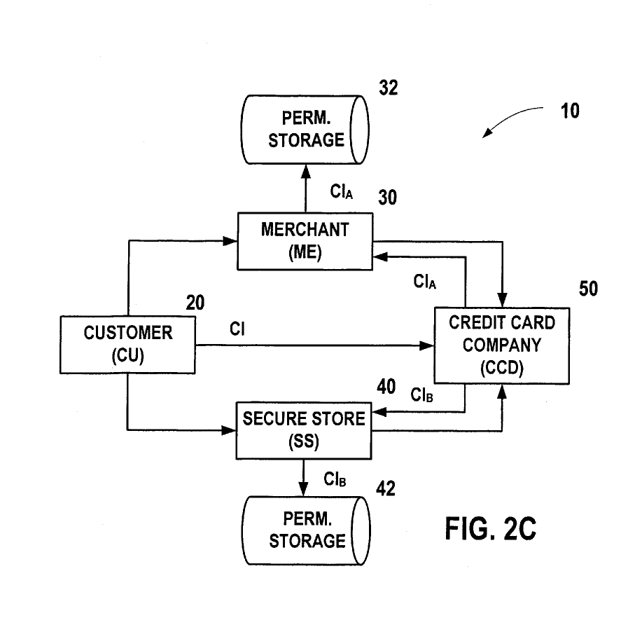

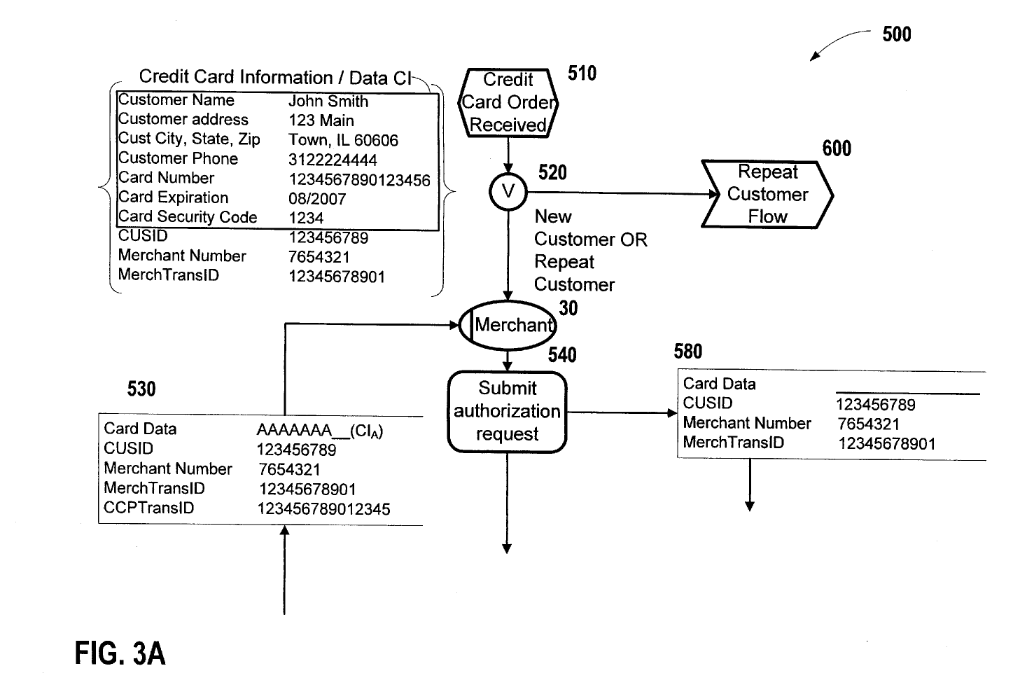

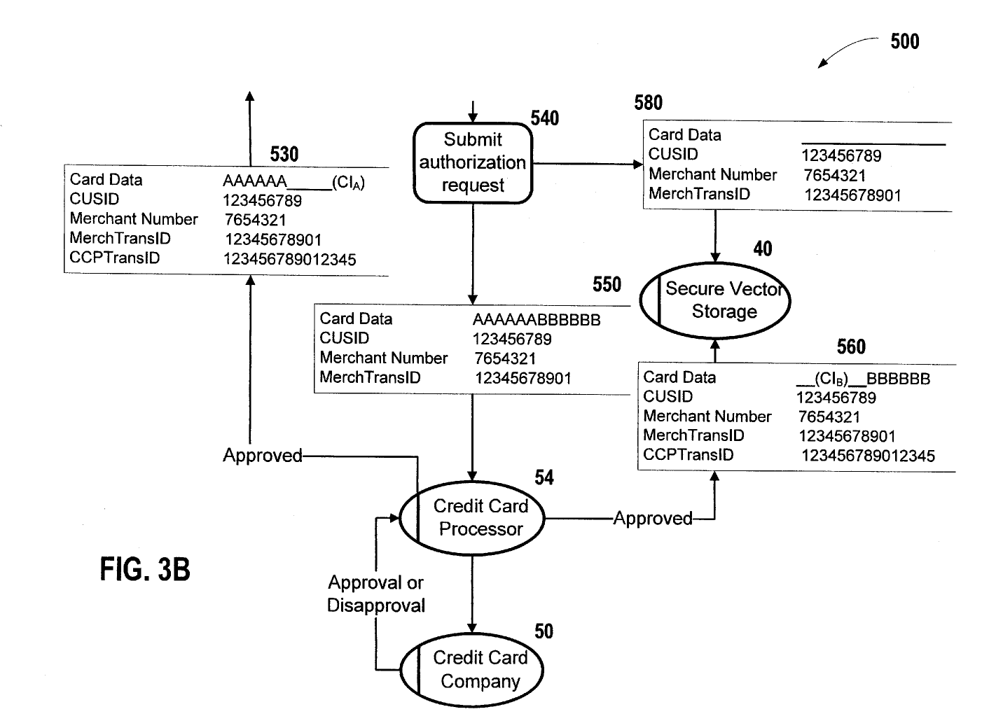

Referring to FIGS. 2A, 3A, and 3B, when a customer 20 makes an initial credit card order with a merchant 30, the customer 20 sends all pertinent credit card information/data CI to the merchant 30, just as would be done with a normal credit card purchase. However, if the customer 20 designates with the merchant 30 that this purchase is to be an initial secure store purchase (with any form of data indicator or marker, or possibly with procedural mechanisms such as telephoning the merchant 30), then the new secure store customer procedures are invoked. A test 520 at the merchant is performed to determine if this is a new or a repeat secure store customer 20, and if it is a repeat, then the repeat procedures 600, described in more detail below, are undertaken.

For the initial transaction, a process submits the authorization request 540 via a credit card processor 54 (which may include the splitter 22) including all of the card data CI plus information relating to the customer ID CUSID, merchant number, and merchant transaction ID 550. This information 550 is then passed on to the credit card company 50 and the transaction is approved or disapproved just as any normal credit card transaction would be. An approval or disapproval is sent back to the credit card processor 54.

The credit card processor 54, however, splits the approved credit card information into two pieces CI_{A} and CI_{B}, and, after optionally including additional information, sends the two pieces CI_{A}, 530 and CI_{B}, 560 to two separate places: the merchant 30 and the secure store 40, as a secure vector storage location. The actual splitting can be performed by predefined algorithms or by some indication as to how the information should be split provided by the customer.

In this case, both the merchant 30 and the secure store 40 can then store the information in their respective permanent storage 32, 42, without having the permanently stored credit card data being vulnerable to attack at a single point. The secure store can receive additional information about the merchant, the transaction, and the customer 580 from the process that submits the authorization request. This information can additionally be provided by the credit card processor 54 with the second part of the card information CI_{B}.

Although it is possible for a hacker to access one secure location in order to obtain stored credit card information, it would be extremely difficult for the hacker to do so if the information is stored in more than one place. Therefore, the data is never ultimately stored in a way that can be compromised in any reasonable manner.

Customer Splitter

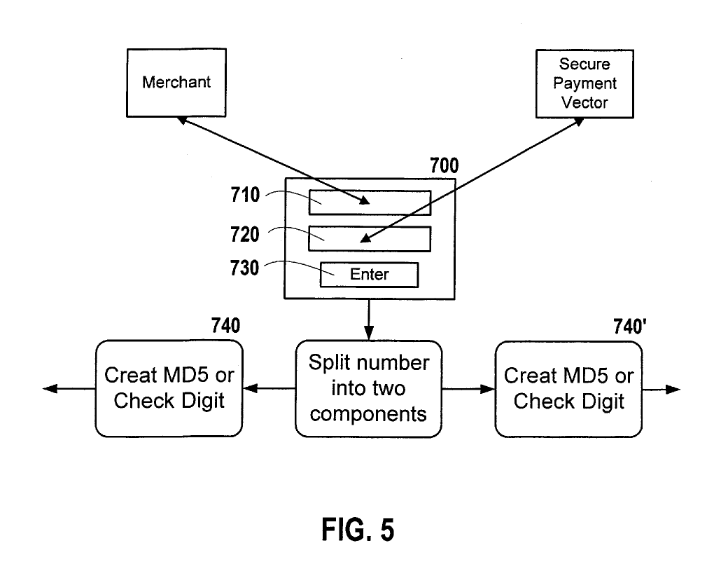

In another embodiment, the customer 20 herself can split the credit card information. This can be accomplished by, e.g., the customer accessing the secure store 40 and providing the partial information to the secure store 40 to be stored there. As shown in FIG. 5, the split of the credit card number can be accomplished by the user entering, into a dialog entry box 700 a portion of the credit card number 710 for the merchant 30, and a portion of the credit card number 720 for the secure store 40, and then pressing an enter button 730, which initiates the splitting routines. An MD5 or check digit may be added 740, 740′ for additional reliability/security.

As shown in FIG. 5, the customer 20 selects the payment card type and is prompted to enter a portion of the card number into the form 700, e.g., ½ of the number into one box, and ½ into another. This is the simplest entry mechanism for the simplest split of credit card information CI, however, one of skill in the art would appreciate that more complex dialog boxes could be presented where a more complex mechanism for splitting (such as that using public and private key encryption) is utilized.

The merchant 30 is then informed that another portion of the customer's 20 credit information is stored at the secure store 40, and the merchant 30 can pass this (i.e., the fact that the secure store 40 holds additional credit information, but not the actual additional information itself) on to the credit card company 50.

This embodiment is more desirable from a security standpoint in that the merchant never has access to the customer 20 credit card information, even for the first transaction. However, this does require additional effort on the part of the user.

Credit Card Company Splitter

In another embodiment of the invention, as illustrated in FIG. 2C, the credit card company 50 can split the data itself. It should be noted that in an embodiment, the split would be a merchant-specific split mechanism (this embodiment can be used regardless of the splitter). The partial credit card information 70 could be mathematically operated on in some way with, e.g., a secure merchant number (that uniquely identifies a particular merchant, but is known only by the credit card company). Thus, in this embodiment, this portion can only be used for the merchant's benefit, which provides a level of security. The split would be made the first time a customer 20 made a purchase with a particular merchant 30 using a credit card of the credit card company 50.

The credit card company 50 could then send the two pieces CI_{A}, and CI_{B}, to two separate places: respectively, the merchant 30 (for permanent storage 32) and secure store 40 (for permanent storage 42), as a secure vector.

Secure Store Splitter

In another embodiment, illustrated in FIG. 2B, the secure store 40 can split the data. A customer 20 wishing to engage a particular merchant 30 in credit card transactions initially contacts the secure store 40, either via a web-based application or possibly some other OS-based application and possibly in a client-server architecture, and provides information about the merchant as well as information about the credit card CI. The secure store 40 then splits the credit card information CI into two pieces CI_{A}, and CI_{B}, storing 42 the second piece and providing the merchant 30 with the first piece CI_{A}.

The merchant 30 then subsequently realizes that purchases from this registered customer 20 are secure store purchases, and can then accept partial credit card information CI_{A} for a purchase from that customer 20 with the understanding that secure store 40 has the other part of the credit card information CI_{B}.

### Credit Card Information Combining and the Subsequent Secure Store Purchases

As discussed above, an initial credit card purchase by a customer 20 with a merchant 30 requires a splitting of the credit card information CI by some entity in the system so that the credit card information can be stored in at least two different places.

Once the second part of the credit information is stored CI_{B}, subsequent purchases can be made without requiring combined credit card information CI to be present at any place besides the credit card company 50. At some point, and as illustrated in FIG. 1B, the two pieces of credit card information CI_{A}, CI_{B} are brought together in a combiner 52, which is preferably located at the credit card company 50 or at least at some location within the credit card company's 50 firewall or accessible over a secure link. The goal is to not permit the combined credit card information CI to be at rest anywhere except in an area ensured to be secure with regard to the credit card company 50.

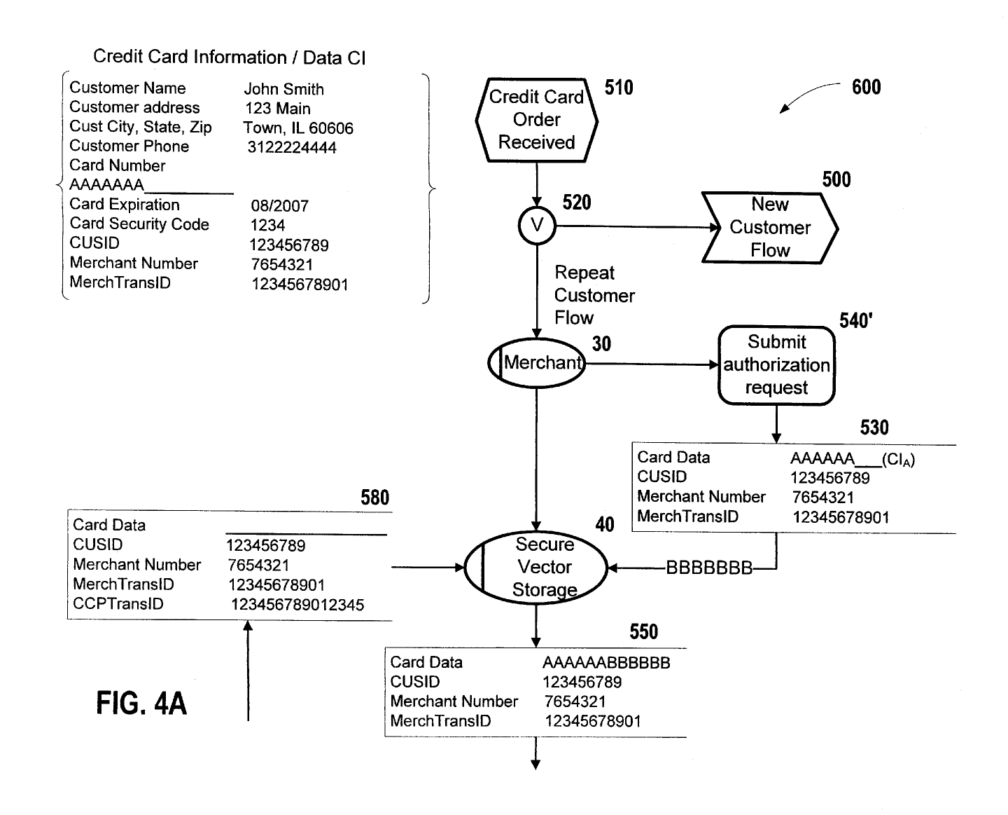

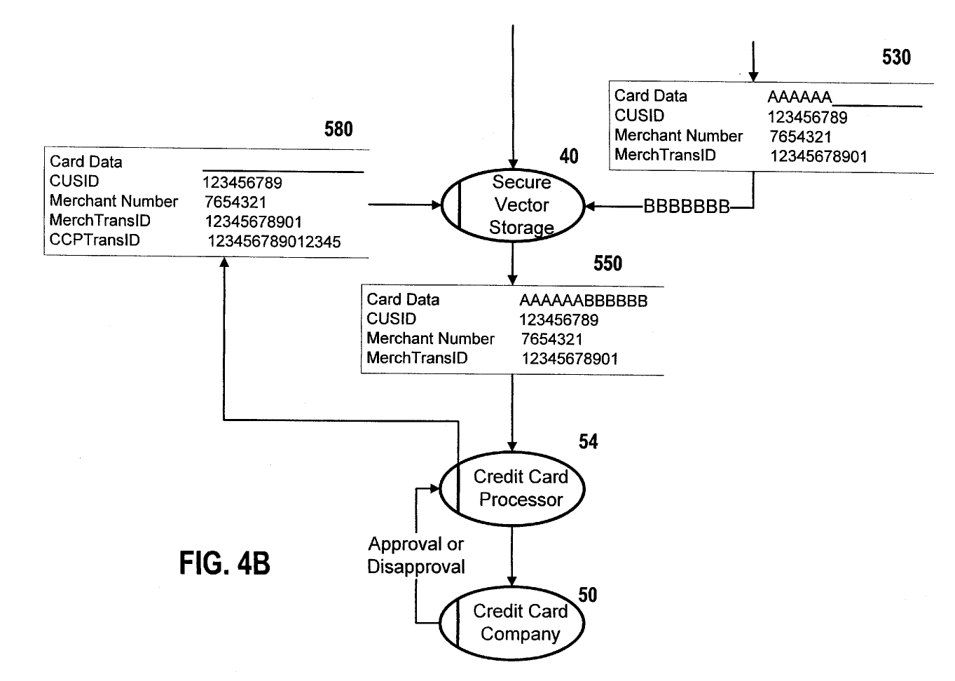

In an embodiment of the invention as illustrated in FIGS. 4A, 4B, process 600 is implemented for a repeat customer. A credit card order is received 510 by the merchant 30, and a determination is made as to whether this is a new secure store customer or a repeat secure store customer. If the former, the new customer procedure 500 as described above is executed.

If, however, this is a repeat customer, then the flow proceeds somewhat differently. The merchant submits an authorization request 540′ using the first part of the credit card information CI_{A} that the was either stored 32 by the merchant 30 (in this scenario, the customer need only provide some form of a code, such as a customer ID, that would permit the merchant 30 to retrieve the first part of the credit card information CI_{A}) from storage 32. In an alternate embodiment, the first part of the credit card information CI_{A} could originate from the customers 20 themselves.

There are a number of different mechanisms that can be used to convey both parts of the credit card information CI_{A}, CI_{B} so that they can be joined by the credit card company 50. In the embodiment illustrated in FIGS. 3A, 3B, the merchant 30 submits a credit card authorization request 540′ containing the first part of the credit card information CI_{A} through the secure store 40. This can then be passed on to the credit card processor 54, and subsequently, the second part of the credit card information CI_{B} is provided to the credit card processor 54, at which point the information can be combined and sent to the credit card company 50 for approval or disapproval. In this configuration, the first part of the credit card information CI_{A} is always in flight on the secure system 40 and is not stored anywhere so that the combined and complete credit card information CI is not located in permanent storage.

However, there are alternate mechanisms by which the credit card processor 54 and credit card company 50 can obtain both parts CI_{A}, CI_{B} of the credit card information so that they can be combined and acted upon by the credit card company. The credit card company 50 can pull both pieces of information from the merchant 30 and secure store 40 upon receiving a credit card purchase request devoid of credit card information. Alternately, either one or both pieces of the credit card information CI_{A}, CI_{B} can be pushed to the credit card processor 54 and credit card company 50.

In one embodiment, the merchant 30 includes the first part of the credit card information CI_{A}, and then the credit card company 50 contacts the secure store 40 to obtain the second part CI_{B}. The relevant transaction ID MerchTransID and Merchant Number can be provided by the credit card processor 54 to the secure store 40 so that it knows which appertaining second part CI_{B} to retrieve and provide to the credit card company 50.

In an alternate embodiment, the merchant 30 sends relevant transaction information to the secure store 40 indicating that the secure store 40 should send the second part of the credit card information to CI_{B} the credit card processor 54 and ultimately the credit card company so that the two pieces can be combined. Regardless as to whether the two pieces of credit card information CI_{A}, CI_{B} are pushed to the credit card processor 54 and credit card company 50 or are pulled by these entities, the concept is the same: the separated credit card information CI_{A}, CI_{B} is combined at the credit card processor 54 for the credit card company 50, at which time the transaction is either approved or disapproved.

### Specific Examples

In a general sense, customers 20 can interact with merchants 30 in several ways: by telephone, both wired and wireless, by website, by direct mail and e-mail, and by fax, and each of these methods can interact with a secure vector as possibly stored on a secure vector storage system 40 in either direct, or immediate mode, or indirect, or delayed mode.

TABLE 1
Access Methods

| Communications | Secure Vector |
|---|---|
| Media | Access Method |
| telephone - wired | direct |
| telephone - wireless | direct |
| telephone SMS | direct |
| Telephone - Web | direct |
| Web site | direct |
| Fax | indirect |
| Postal Mail | indirect |

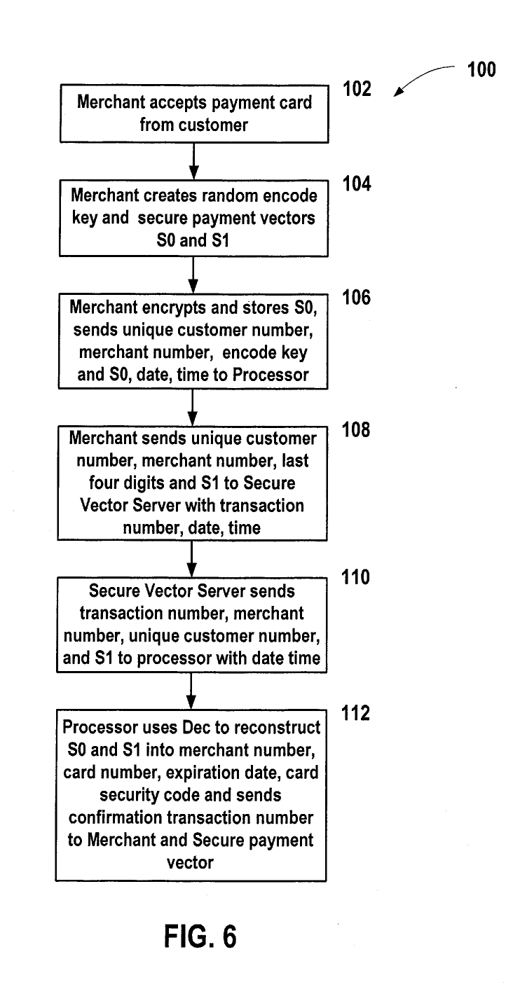

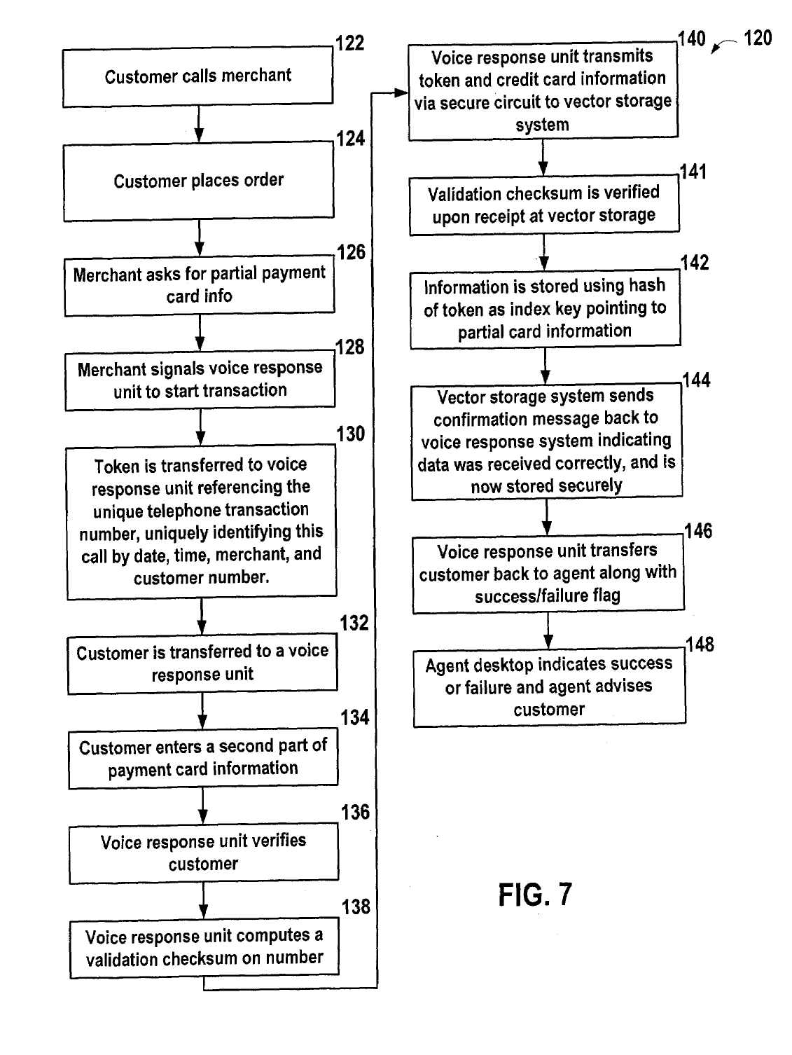

FIG. 6 illustrates a more detailed variation utilizing encode keys and secure vectors. As illustrated in FIG. 6, the process 100 begins with the merchant 30 accepting 102 the payment card information from the customer 20. The merchant 30 then creates 104 a random encode key and secure vectors S0 and S1. The merchant 30 encrypts and stores 106 the first secure vectors S0, and sends a unique customer number, merchant number, encode key, and first secure vector S0, date, time to the credit card processor 54.

Next, the merchant sends 108 the unique customer number, merchant number, last four digits of the credit card information and the second secure vector S1 to the secure vector server 40 with the transaction number, date, and time. The secure vector server 40 sends 110 the transaction number, merchant number, unique customer number, and second secure vector S1 to the processor 54 with the date and time.

The processor 54 reconstructs 112 the first and second secure vector S0, S1 into merchant number, card number, expiration date, card and security code, and sends a confirmation transaction number to the merchant and secure vector server 40.

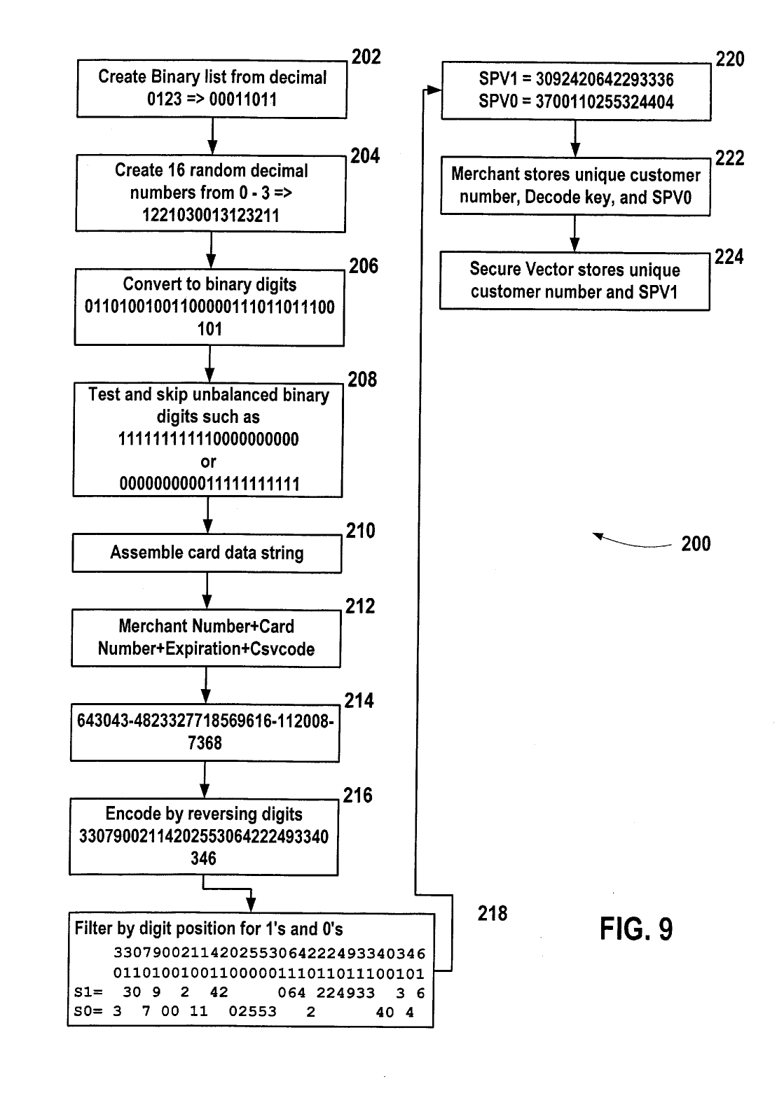

FIG. 9 illustrates a tangible example of performing this process 200. As illustrated, and by way of example only, a binary list is created 202 from the decimal number, and sixteen random decimal numbers from 0-3 are created 204, which are then converted into binary digits 206.

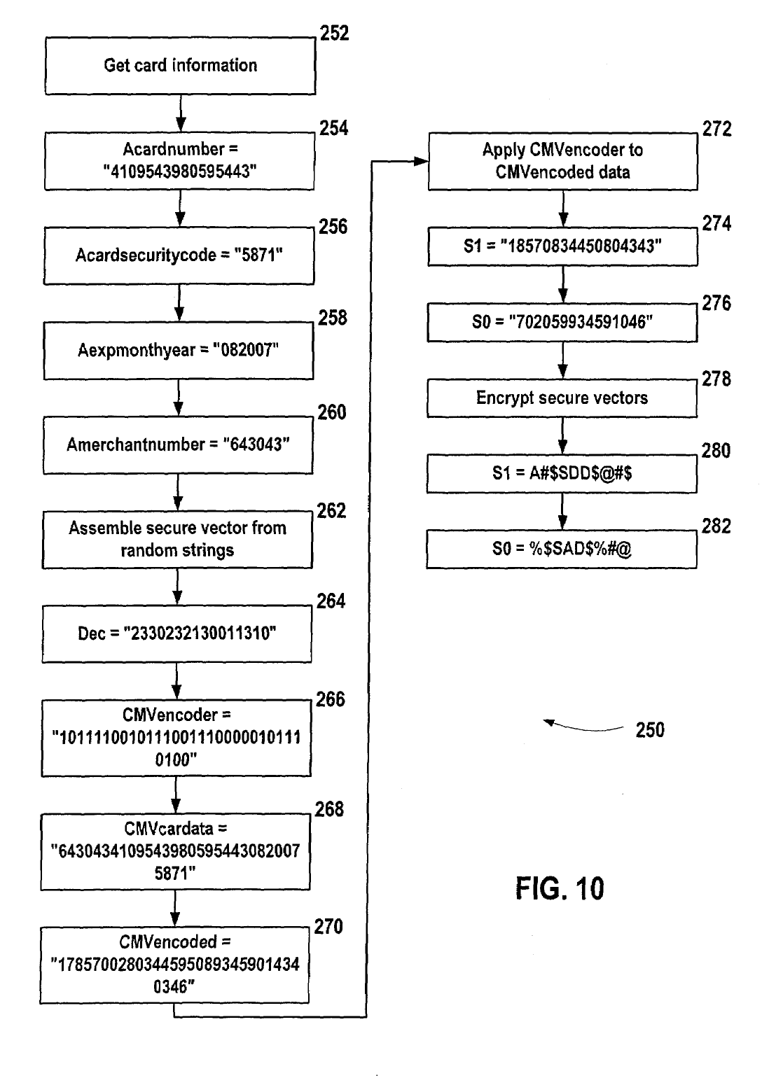

A test is performed to ensure balance and unbalanced numbers are skipped 208. The card data string is assembled, and can include the merchant number, card number, expiration, and DSV code 210-214. The resultant string of digits may then be encoded by reversing the digits 216 and this is then filtered by the digit's position for 1s and 0s according to the secure vector S0, S1 218, producing the resultant vectors (SVS0, SVS1) 220. The merchant 30 can then store the unique customer number, decode key and vector information SVS0. The secure vector server 40 can store the unique customer number and the vector information SVS1. FIG. 10 provides exemplary steps for the data and encoding procedures 250-282.

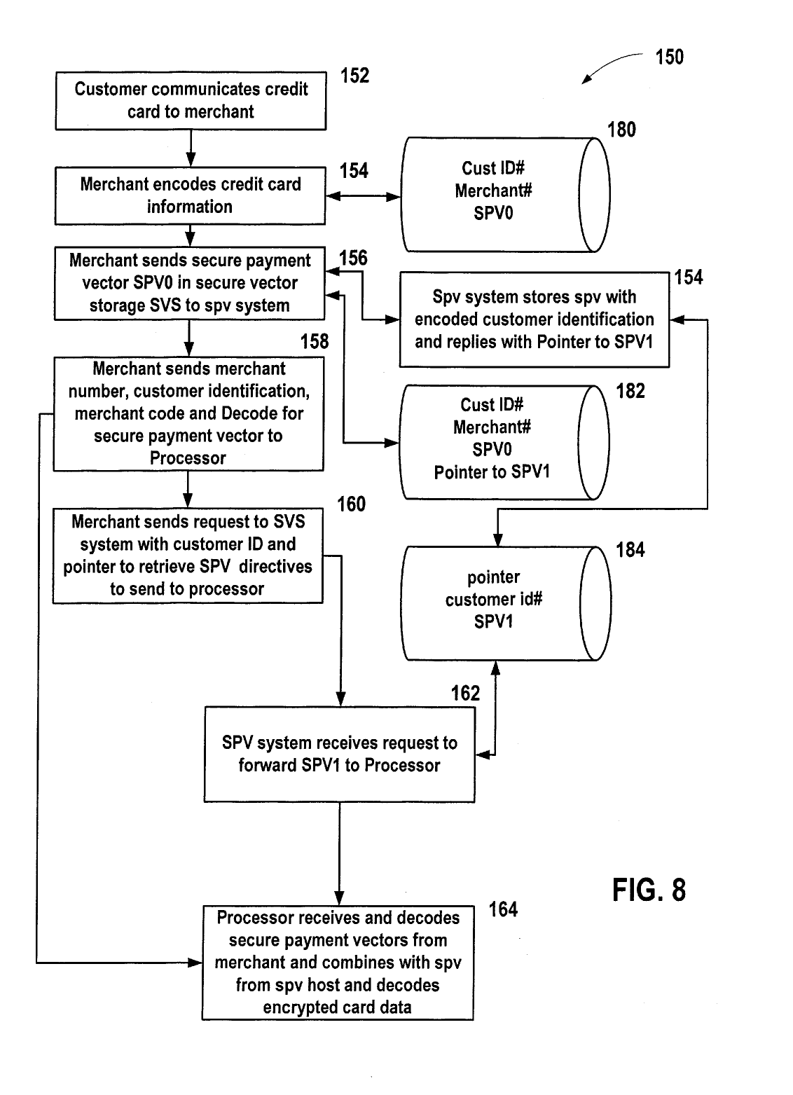

FIG. 8 illustrates en embodiment of the process flow 150 relating to the storage of the secure vector. It should be noted that the secure vectors SVS0 and SVS1 closely correspond to information related to the first part of the credit card information CI_{A} and second part of the credit card information CI_{B} respectively.

According to the exemplary flow, the customer 20 communicates 152 the credit card information to the merchant 30, and the merchant encodes 154 the credit card information and stores a first part SVS0 (CI_{A}) along with the customer ID No. and the merchant no. in a data storage area 180. The merchant 30 sends 156 the secure vector SVS0 to the secure store, and the secure store 40 stores relevant information and replies 154 with a pointer to the second secure vector SVS1 (CI_{B}), which is stored along with the customer id number 184.

The merchant 30 then sends 158 the merchant number, customer identification, merchant code and decode for the secure vector to the processor 54. The merchant 30 further sends 160 a request to the secure store 40 with the customer ID and a pointer to retrieve the secure vector directives to send to the processor 54. The secure store 40 receives 162 the request to forward the second secure vector SVS1 to the processor 54, which it performs the forwarding from its storage location 184. The processor 54 then receives and decodes 164 the secure vector SVS0 (CI_{A}) from the merchant and combines it with the secure vector SVS1 (CI_{B}) from the secure store 40 and decodes the encrypted card data.

As illustrated and discussed above, the following restates the procedure with a slightly different focus. When a customer 20 makes a credit card purchase at a merchant 30, the merchant 30 assembles a string of data to submit the transaction to the credit card processor 54. This data may comprise: the credit card number, the card expiration date, the card security code, a transaction ID no., a customer ID no., plus the necessary transaction details.

As to the use of key information, the merchant 30 then transmits the data (encrypted) along with a private merchant key to the processor 54. The processor 54 then encodes the card information with the public merchant key, splits it into two pieces and sends half of the encoded value back to the merchant 30 along with a record identifier. The processor 54 further uses part of the encryption key so that each record is dynamically encrypted, making compromise of the entire database impossible.

As a result, the card information exists only when the merchant 30 submits the record identifier, the half of the encoded data, plus the merchant decode key back to the processor 54, where the other half of the data is stored encrypted with the merchant key. Neither the merchant 30 nor the processor 54 has access to the card data without the cooperation of the other party, and the card data is stored only for the benefit of the merchant 30. A thief would have to compromise both locations and multiple algorithms to be able to gain access to the data. Use of this mechanism reduces the risks involved in storing card information to a level that it would significantly reduce the costs associated with safe and secure storage of card information.

In the web-based implementation, once encoded, the encrypted value may be converted back into a URL encoding format for transport via http as necessary. This value is then split into two or more segments using a reversible algorithm. This algorithm, moreover, can be a part of a mechanism to share and update or change the algorithm and encryption keys dynamically, so that compromising one set of encryption methods does not compromise all values. In the simplest method, the string is split into two halves. In a more complicated method, the string is extracted two or more characters at a time according to a method that can be reproduced for reassembly of the string.

A unique number is then created, and it is concatenated with the merchant identifier; this is then concatenated with half of the encrypted representation of the credit card information, and sent back to the merchant 30. Once acknowledgement has been received that the merchant 30 has received the data, the processor system 54 deletes the half of the encoded value that now resides only at the merchant 30.

The merchant associates the encoded package with the customer information. When a repeat transaction is initiated, the merchant system 30 transmits this package, including the unique key and the half of the encoded card data to the processor 54. At the processor 54, the system uses the unique number to look up the stored half of the card data, reassembles the card information according to the algorithm, and then decodes the card number and merchant number.

This system reduces the attack surface of customer credit card information in several ways. First, the card information is not accessible at any one location. Second, even if both components of the card information are somehow recovered, they are further encrypted so that the merchant identifier is an integral part of the stored value.

The use of this mechanism greatly reduces the potential for theft of credit card information. It deters thieves from attempting to gain access to either merchant or processor systems, since neither contains the complete card information. Moreover, since keys and algorithms can change by merchant, any attempt to compromise card information would have to also have the current merchant keys and algorithms as well as the card data component stored at the merchant.

### Use of Voice Response Unit in Telephone Implementation

FIG. 6A illustrates an exemplary splitting apart of the customer's 20 credit card information using a voice response unit (VRU) in a telephone-based (wired or wireless) implementation. In this process 120, the customer 20 calls 122 a merchant 30 and places an order 124, indicating that this is to be a secure store purchase. The merchant 30 then asks for partial credit card information CI_{A} for payment 126. The merchant 30 signals 128 that a VRU is to start the transaction. A token is transferred 130 to the VRU referencing a unique telephone transaction number and uniquely identifying this specific call by date, time, merchant number, and customer number.

At this stage, the customer 20 is transferred 132 to a VRU. The customer 20 enters 134 the second part of the credit card payment information CI_{B} and the VRU verifies 136 that the customer 20 is who he says it is. The VRU computes 138 a valid checksum on the number provided and transmits 140 a token and the credit card information CI_{B} via a secure circuit to the vector storage system 40, 42. A validation checksum is verified 141 upon receipt at the secure system 40 vector storage 42 location. The information may be stored 142 using a has of the token as an index key pointing to the partial card information CI_{B}. The secure store 40 sends 144 a confirmation message back to the VRU indicating that the data was received correctly and is now stored securely. The VRU, having received this confirmation, then transfers 146 the customer 20 back to an agent of the merchant 30 along with a success/failure indication. The agent, upon receiving the status, then informs 148 the customer 20 as to the status.

Note that the VRU could work locally or remote. In a preferred embodiment, the VRU is located at a remote location, such as the secure vector server where the portion of the data is taken, or at the credit card company. The call is transferred to the VRU, and then transferred back (or not, if issues exist) once the entry of the information is complete. If no transfer back is possible, then the VRU is the last step in the phone call process.

However, the VRU could also be located at the merchant, but such a configuration runs a greater risk of a security breach. In any case, this can be provided as a service, and not as an equipment sale, of a VRU. The VRU could be a service bureau operation.

### Web-Based Implementation

The secure store system can also be implemented in a web-based implementation in which the concepts remain the same, but the implementation varies somewhat.

In this scenario, the customer 20 goes accesses a merchant 30 website to make a purchase. A unique customer number (UCID) is created with merchant number and customer number. A transaction ID (TRID) is created with the merchant number, customer number, date, time, and transaction number.

In an embodiment, the website presents an option for the customer 20 to enter data into one site or two sites. If the customer 20 selects the option to enter data into one site, a form is displayed for the entry of credit card information CI. The customer 20 then enters the credit card information CI, and is prompted to enter a password to permit a future use and retrieving of the credit card information CI.

Also in the web-based embodiment, the credit card information CI is split into two pieces: the first portion CI_{A} is encrypted and stored on the merchant website 32 keyed by a hash (a mathematical manipulation of the number so that it cannot be read without the hash algorithm) of the UCID and customer password. The second portion CI_{B} is transmitted to the secure store 40 along with the hashed UCID and is stored 42 there indexed by the hashed UCID along with the customer password.

If the customer 20 selects the two site entry option, then a form is displayed for entry of the first portion of the credit card data CI_{A}. A second form or a pop-up window opens, with a secure store 40 website entry form. The customer 20 then enters the second part of the credit card information CI_{B} into to secure vector store 40 website form. The first portion CI_{A} is encrypted and stored on the merchant website 32 keyed by a hash of the UCID and customer password, and the second portion CI_{B} is stored at the secure vector store 40 indexed by the hashed UCID and customer password.

The procedure for repeat customer purchases similarly follows. The customer 20 accesses the merchant 30 website to make a purchase. The unique customer number (UCID) is verified with the merchant number and the customer number. A transaction ID (TRID) is created with the merchant no., customer no., date, time, and transaction number.

If this is not an encapsulated transaction, the customer 20 selects an item to purchase and chooses an option to complete sale. If this is an encapsulated transaction (i.e., all data necessary to complete the transaction is encapsulated within the data sent by the customer . . . no customer choice has to take place), then there is no need to execute the step of having the customer 20 select an item.

The customer 20 is then prompted to enter their password. The transaction ID and encrypted customer credit card information are sent to the combiner 52 which may reside within the credit card processor 54 or other consolidation system. The UCID, transaction ID and encrypted customer password may then be sent to secure vector system 40. The secure vector system 40 then sends its credit card information CI_{B} to the consolidation system 54. Note that the consolidation system/credit card processor 54 (combiner 52) is a secure system capable of receiving and consolidating transactions involving a merchant 30 and secure vector store system 40. In various embodiments, this system receives and consolidates, but has no way to decrypt or store, the information it processes. It may keep a record of the transactions it receives and processes, but these numbers have no relationship to the underlying information, as they are purely tracking codes. The consolidation system can exist at the credit card processor, the merchant, or at a secure vector location. The consolidation system forwards the complete transaction to the payment card processor to complete the transaction.

### Authentication of Customer

In these various arrangements, the merchant 30 should provide for authenticating the customer 20 in some way. For computer access, passwords and the like can be used. For in-store purchases, a visual inspection of the customer's 20 driver's license or credit card can serve the role of separating the real customers from imposters. Additionally, and form of biometric identification may be used. By providing this assurance, the odds of improper access by an imposter are minimized, even if the imposter has access to the partial credit card information.

The customer 20 is able to make a repeat purchase from the merchant 30 without having to disclose their payment card information each time, even though the merchant 30 does not have the complete card number in its computer system. The merchant 30 may retain a portion of the card number CI_{A} on a separate system 32 that stores one component of the secure vector.

To recover the card information, in a preferred embodiment, it is necessary to have the merchant number, the unique customer record identification number, and the generated random key used to split the payment card information between merchant and secure vector system, as well as the credentials and authorization ability to cause the secure vector system to send it's portion of the card information the processor. There is no mechanism to retrieve the information stored at the secure vector storage location except for the purposes of submitting a payment to the processor for the customer's account at the merchant.

One of the data elements referred to in this document is the card security code, or CVV, or CSV. This code is stored on the magnetic stripe and the same type of code is printed on the front or back of the card in non-embossed letters. This code serves to prove that the actual card was present and was swiped by a reader, or that the customer has the card in their possession, and not a sales receipt or copy of the card number and expiration date. It should be noted that this data element is never permitted to be written to magnetic media under any circumstances dues to its high sensitivity. It is a fundamental element of intrinsic card value, and must be protected at all times.

There is a significant discount for “card present” transactions compared to transactions where the card is recorded over the telephone or online. The ability of the above described mechanism and process to securely and safely store components of the card number in secure separate facilities can make it possible to store all of the required card information to achieve the lowest possible rate for repeat transactions using a secure vector. The card code included in the computations and encoding can be considered to be any other digit value if the card security code cannot be stored due to card company regulations.

The card data is completely secure for several reasons. First, it cannot be stolen from the merchant or the processor, because it does not exist at the merchant or the processor. Only part of the card information exists at the merchant, and only part of the card information exists at the secure vector storage. Neither has access to the card information until the merchant submits another transaction with the merchant's component of the secure vector, decode key, and the customer account number.

The secure vector does not compromise the customer's general credit account, because it exists only in a form that can be utilized for the benefit of the customer for a purchase made with the merchant. The merchant payment vector is encoded or encrypted according to an algorithm. The customer identification number is a unique number that has no mathematical relationship to the stored information. Thus, to compromise the customer card data, one would have to know where the data is stored and how to gain access to that facility, how it is stored (the merchant specific algorithm), the customer identifier (unique to each merchant), and then and only then one would have to gain access to the processor's system, know how the processor portion of the card data is encrypted, and then how to combine the information so as to arrive at a valid card number.

In addition to the examples presented, however, a wide variety of methods for key management and obfuscation, salting, and encryption are available to protect the data with varying degrees of security. The examples given demonstrate some simple methods of obfuscation to demonstrate that an algorithm may be used to conceal specific data items, and how these methods can make it virtually impossible, or at the very least prohibitively expensive, to compromise information stored as secure vectors in more than one location.

An even higher level of security and redundancy can be achieved by distributing the data in a redundant storage array of e.g., five or more locations where data can be recovered from any, e.g., four locations using techniques similar to those used for redundant disk storage systems that use specific coding for data recovery. Data can be algorithmically distributed to multiple devices where parity bits and other codes assure that data can be recovered even if one of the disks fails.

In an embodiment of the invention, the two factor identification can be performed at the time of entry of the credit card information. When calling a store or call center, the customer may be transferred to a voice response system and prompted to enter all or some of their credit card information. This eliminates the possibility of an operator copying down the credit card information and using it.

The voice response system asks for the card number or part of the card number, the expiration date, and the card security code, and then transfer control back to the operator to complete the order processing. If there is a concern about compromising the automated system, only part of the data could be requested and entered (e.g., the first 8 characters of the credit card) and then the operator would be prompted to enter the balance of the information such as expiration date and CSV value. In this way the card data is subjected to two factor authentication at entry.

Depending on the level of security desired, the data could be sent to more than one location for storage, again, providing the two factor protection on storage. But the ability to split the entry of the transaction, whether it be by voice using a voice response system, or by the web, using a form where the data exists only “in flight” and is not committed but only forwarded, is an important part of the concept to be implemented.

As an additional measure of security for the secure vector, when a merchant or a credit card processor connects to the secure store, the preferred mechanisms, depending on volume, could be:
a private telephone (T-1) circuit: this is for high volume, and is the most secure, but it is also the most costly since it is distance measured. But it is always connected and is always available.
a dial-up telephone circuit: this has a per transaction cost, but it is also very secure, since a 3^{rd} party (the telephone company) verifies each endpoint.
Virtual Private Network (VPN) (over the Internet): this is a secure encrypted tunnel that is created between two routers or firewalls. It requires passwords on each side and is secure, but requires maintenance and continuous monitoring and certification.
SSL protected transactions, such as https get and post requests. This can be secure, but would rely on secondary mechanisms such as rotating passwords, and Domain Name Service and IP address verification. This mechanism is potentially vulnerable to DNS tampering, but additional precautions can be taken, such as additional password and IP address checksums.

It should be noted that the above discussion has focused on the use of credit card information (which includes data related a credit card) as the data to be kept secure. However, the invention can be generalized to protect any sensitive information in primarily the same matter. For example, in some industries (such as pizza delivery), having complete and accurate customer delivery information as well as historical information about a location or customer, can be a matter of life and death for a delivery driver dispatched late at night to specific address based on a telephone call. The above system The ability to protect customer information, while at the same time providing the delivery driver the complete historical record of deliveries to a specific locale, can be accomplished with a secure vector that assures both access control as well as an audit trail on customer information

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like. The word mechanism is used broadly and is not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A method for securely storing and retrieving data, comprising:
in a first splitting stage:
splitting, by a splitting entity, a data unit of a data originator into a first component and at least a further second component such that the data unit cannot be reconstructed without having the first and second component; and
storing the second component on a secure server in a non-volatile memory, the secure server being separate from any entity that may store the first component; and
in a second accessing stage:
accessing, by a secure data retriever who is not the data originator, the first component provided directly or indirectly by the data originator;
accessing, by the data retriever, the second component from the secure server;
combining the first component, the second component, and any further necessary components that make up the data unit by the data retriever into a retrieved data unit that is identical to the data unit that was split; and
outputting the retrieved data unit to a user readable device or a system memory.

2. The method according to claim 1, wherein the data unit comprises data related to a PIN, code, combination, account number, password, medical data, customer data, and user proprietary information.

3. The method according to claim 1, wherein the splitting is performed based on a position of data within the data unit.

4. The method according to claim 1, wherein the splitting is performed based on cryptographic techniques.

5. The method according to claim 1, wherein:
the data unit comprises customer credit card information in a context of a purchase by the customer from a merchant; and
the secure data retriever is a credit card company.

6. The method according to claim 5, wherein the splitting entity is the customer.

7. The method according to claim 6, further comprising:
presenting the customer with a data entry element on a display screen;
entering, by the user, data associated with the first component in a first part of the data entry element;
entering, by the user, data associated with the second component in a second part of the data entry element;
sending the data associated with the first component to the merchant; and
sending the data associated with the second component to the secure server.

8. The method according to claim 7, further comprising:
providing a check digit or MD5 on each of the data associated with the first component and the second component, and including the check digit or MD5 with the sending of the components.

9. The method according to claim 5, wherein the splitting entity is the secure server.

10. The method according to claim 5, wherein the splitting entity is the credit card company.

11. The method according to claim 5, wherein the splitting entity is the merchant.

12. The method according to claim 11, further comprising:
determining by the merchant if a purchase by the customer is a first secure purchase;
if yes (for an initial secure purchase):
submitting, by the merchant, an authorization request to the credit card company with the data unit; and
if the credit card information is approved by the credit card company, then performing the splitting of the data unit by the merchant and performing the storing of the second component of the data unit; and
if no (for a subsequent purchase):
obtaining the first component by the merchant from the customer;
providing the first component to the credit card company either directly or indirectly;
initiating, by the merchant, the accessing of the second component by the credit card company and initiating, by the merchant, the combining of the first and second components.

13. The method according to claim 12, wherein the secure store pushes the second component to the credit card company.

14. The method according to claim 12, wherein the credit card company pulls the second component from the credit card company.

15. The method according to claim 11, further comprising:
asking, by a customer representative of the merchant, for the first component information from the customer;
transferring the customer to a voice response unit with a token referencing unique telephone transaction identification information;
providing, by the customer, the second component information to the voice response unit;
transmitting the second component information to the secure store;
transferring the customer back to the customer representative and indicating success or failure of the transmitting.

16. The method according to claim 15, wherein the voice response unit is located at the secure server.

17. The method according to claim 15, wherein the voice response unit is located at the merchant.

18. The method according to claim 15, wherein the voice response unit is located at the credit card company.

19. The method according to claim 11, further comprising:
creating, by the merchant, a random encode key and first and second secure payment vectors;
encrypting and storing, by the merchant, the first secure payment vector;
sending, by the merchant to a credit card processor, a unique customer number, a merchant number, the encode key, and the first secure payment vector;
sending, by the merchant to the secure store, the unique customer number, the merchant number, a portion of the credit card number, and the second secure payment vector, a transaction number, its date, and time;
sending, by the secure store to the credit card processor, the transaction number, the merchant number, the unique customer number, and the second secure payment vector with the date and time; and
reconstructing, by the credit card processor, the first and second secure payment vector, into the merchant number, the credit card number, expiration date, and card security code; and
sending, by the credit card processor, a confirmation transaction number to the merchant and to the secure store.
